(19) United States
(12) Patent Application Publication
(10) Pub. No.: US 2009/0119827 A1
(43) Pub. Date: May 14, 2009

(54) Bathroom dehumidifier

(76) Inventor: Richard M. Sokolowski, Shelton, CT (US)

Correspondence Address: JAMES RAY & ASSOCIATES, 2640 PITCAIRN ROAD, MONROEVILLE, PA, 15146, US

(21) Appl. No.: 12/291,471

(22) Filed: Nov. 10, 2008

Related U.S. Application Data
(60) Provisional application No. 61/002,291, filed on Nov. 8, 2007.

(51) Int. Cl. E03D 1/00; F25D 23/00; B01D 19/00

(52) U.S. Cl. 4/353; 62/271; 96/188; 96/156

(57) ABSTRACT

In combination with a toilet tank of a toilet in a bathroom, the improvement comprising a dehumidifier having a predetermined shape for one of being wall mounted or disposed on a top of such toilet tank. A humidity sensor is disposed one of on and in the dehumidifier for sensing humidity in such bathroom. A tray member is disposed one of on and in the dehumidifier for collecting water removed from air by such dehumidifier. A flexible member is engageable on a first end thereof with the tray member for removing and transporting such water collected by the dehumidifier and for disposing such water into the toilet tank. There is, also, a power member engageable with the dehumidifier and the humidity sensor for providing electrical power to such apparatus.

### CROSS REFERENCE TO RELATED APPLICATIONS

This application is closely related to and claims benefit from U.S. Provisional Application Ser. No. 61/002,291 filed Nov. 8, 2007.

### FIELD OF THE INVENTION

The present invention relates, in general, to a bathroom dehumidifier, and, more particularly, the present invention relates to a bathroom dehumidifier that can sit on top of the toilet tank or mounted on a wall close to the ceiling in proximity to the toilet tank and that permits the disposal of collected moisture to the toilet tank.

### BACKGROUND OF THE INVENTION

There is a constant problem in a bathroom with moisture from showers or baths. Mirrors constantly fog up and mold frequently accumulates on the walls which requires constant cleaning. Such mold is also a potential health risk. One solution has been to install a fan in the bathroom that draws all of the moisture and exhausts it outside through a large hose. However, there are problems also with this solution. Heat is wasted by blowing warm air from the bathroom outside. Thus, in order to rid the space of “moist” air, it needs to be replaced with “dry” air which is obtained from other rooms in the house. Another problem is that the hose and fan accumulates moisture and mold which again poses a potential health risk and which eventually becomes clogged and ineffective in removing steamy air from the bathroom.

Thus, it would be advantageous and convenient if there were a simpler and more effective means for ridding the bathroom of moisture without any of the problems that are currently encountered with present systems.

### SUMMARY OF THE INVENTION

In a first aspect the present invention provides an apparatus in combination with a toilet tank of a toilet in a bathroom, the improvement comprising a dehumidifier having a predetermined shape for one of being wall mounted and disposed on a top of such toilet tank. A first means is disposed one of on and in the dehumidifier for collecting water removed from air by such dehumidifier. A second means is engageable with the first means for removing and transporting such water collected by the dehumidifier and disposing such water into the toilet tank. There is, also, a power means engageable with the dehumidifier and the humidity indicator for providing electrical power to such apparatus. A third means is connected to such dehumidifier and such power means for turning such dehumidifier on and off.

In a second aspect there is provided an apparatus for removing moisture from a bathroom. The apparatus comprises a dehumidifier having a predetermined shape for one of being wall mounted and disposed on a top of a toilet tank. A first means is disposed one of on and in the dehumidifier for collecting water removed from air by such dehumidifier. A second means is engageable on a first end thereof with the first means for removing and transporting such water collected by the dehumidifier and disposing such water into a toilet tank. A power means is engageable with the dehumidifier for providing electrical power to such dehumidifier. A third means is connected to such dehumidifier and such power means for turning such dehumidifier on and off.

### OBJECTS OF THE INVENTION

It is, therefore, one of the primary objects of the present invention to provide an apparatus for removing moist air from a bathroom.

Another object of the present invention is to provide an apparatus that would remove moist air from a bathroom that could dispose of the moisture collected into the toilet tank.

Still another object of the present invention is to provide an apparatus for removing moisture from a bathroom that could sit on the toilet tank or be wall mounted close to the ceiling in proximity to the toilet tank.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is block diagram showing the parts of the apparatus for removing moisture from a bathroom.

FIG. 2 is a perspective view of a toilet showing the toilet tank with a dehumidifier disposed thereon.

FIG. 3 is a perspective view of a toilet tank showing the means for transporting water from the dehumidifier to the toilet tank.

FIG. 4 is a perspective view of the dehumidifier mounted close to the ceiling on a wall behind the toilet tank.

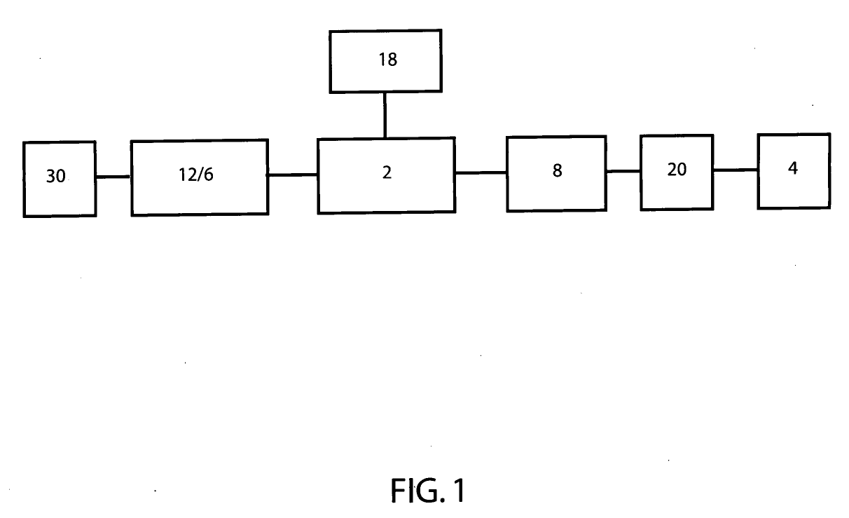

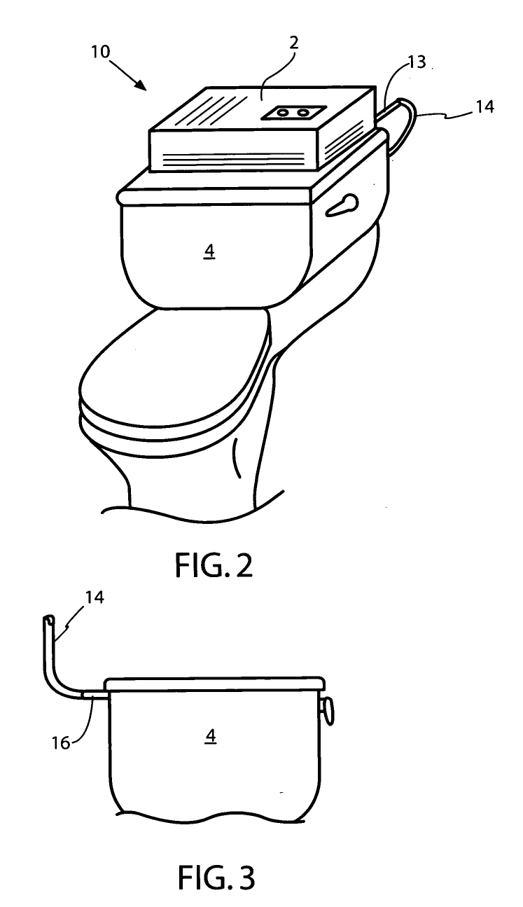

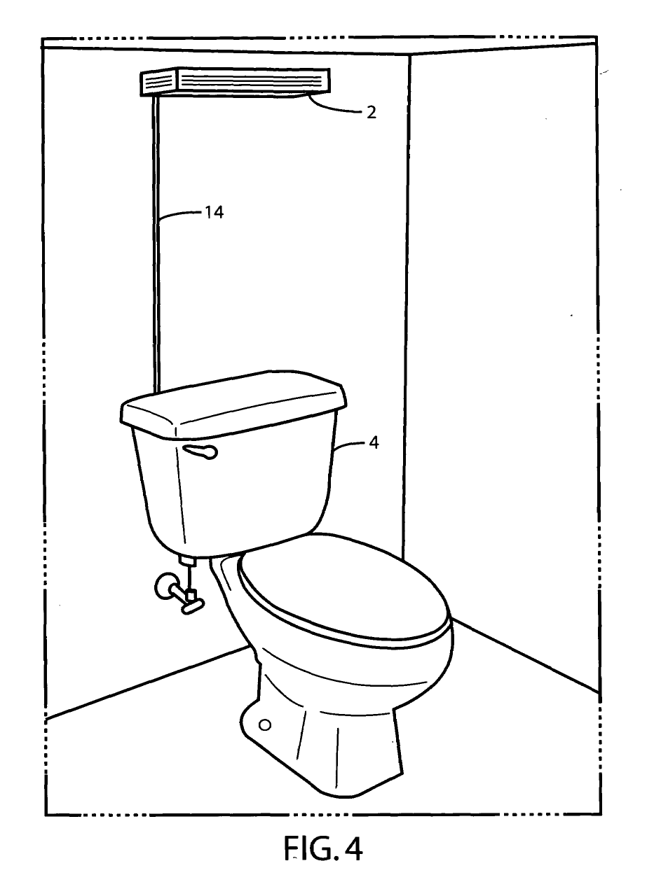

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, in combination with a toilet tank 4 of a toilet in a bathroom, the improvement comprising a dehumidifier 2 having a predetermined shape for one of being wall mounted or disposed on a top of such toilet tank 4. A first means 8 is disposed one of on and in the dehumidifier 2 for collecting water removed from air by such dehumidifier 2. A second means 20 is engageable with the first means 8 for removing and transporting such water collected by the dehumidifier 2 and disposing such water into the toilet tank 4. There is, also, a power means, generally designated 30, engageable with the dehumidifier 2 for providing electrical power to such apparatus. A third means 12 is connected to such dehumidifier 2 and such power means 30 for turning such dehumidifier on and off.

Such third means 12 includes a humidity sensor 6 engageable with the power means 30 and engageable with and disposed one of on and in said dehumidifier 2 for sensing humidity in such bathroom.

Such humidity sensor 6 includes a means for turning on said dehumidifier 2 when such humidity is at a predetermined level and turning off such dehumidifier 2 when such humidity level drops below such predetermined level.

Such first means 8 includes a tray member 8 disposed in said dehumidifier 2. Such second means 20 includes a flexible member 14 connected on a first end thereof to a connecting means 13 of the tray member 8 for transporting water collected in the tray member 8 to such toilet tank 4 for removal of such water. The second means 20 further includes a conduit 16 engageable with the toilet tank 4 and connected on a first end thereof to a second end of the flexible member 14 for transporting water from the flexible member 14 to the toilet tank 4.

The apparatus 10 further includes a switch means 18 engageable with the dehumidifier 2 for turning on the dehumidifier 2 even if the humidity is below the predetermined level. Such switch means 18 further can override the humidity sensor 6 and turn the dehumidifier 2 off even if the humidity is above such predetermined level.

The power means 30 includes one of a standard 110 volt house power or a rechargeable battery. The rechargeable battery is useful where there is no electrical outlet close to the apparatus 10 and where an electrical cord would have to be stretched across the bathroom to reach the outlet. However, it is presently preferred that such power means 30 is a standard 110 volt house power.

The dehumidifier 2 may include a desiccant to absorb moisture and such moisture can be extracted and removed from the desiccant and thereby permitting the desiccant to be reusable.

In the embodiment where the dehumidifier 2 is mounted on the wall it is preferred that it is mounted close to the ceiling on the wall behind the toilet tank 4. Such dehumidifier 2 is mounted between about 6 inches and about 12 inches from the ceiling. Further, it is presently preferred that the flexible member 14 run down the wall to the toilet tank 4 and be covered with a decorative molding so as to make the flexible member 14 relatively inconspicuous. Such dehumidifier 2 may also sit on top of the toilet tank 4.

It is also preferred that the apparatus further include a water level indicator which will turn off the dehumidifier 2 in case of a plug in the second means 20. Such water level indicator further includes a light that turns on indicating that the second means 20 needs to be checked.

In a second aspect there is provided an apparatus for removing moisture from a bathroom. The apparatus 10 comprises a dehumidifier 2 having a predetermined shape for one of being wall mounted and disposed on a top of a toilet tank 4. A first means 8 is disposed one of on and in the dehumidifier 2 for collecting water removed from air by such dehumidifier 2. A second means 20 is engageable on a first end thereof with the first means for removing and transporting such water collected by the dehumidifier 2 and disposing such water into a toilet tank 4. A power means 30 is engageable with the dehumidifier 2 for providing electrical power to such dehumidifier 2. A third means 12 is connected to such dehumidifier 2 and such power means 30 for turning such dehumidifier on and off.

Such third means 12 includes a humidity sensor 6 engageable with the power means 30 and engageable with and disposed one of on and in said dehumidifier 2 for sensing humidity in such bathroom.

Such humidity sensor 6 includes a means for turning on such dehumidifier 2 when such humidity is at a predetermined level and turning off such dehumidifier 2 when such humidity level drops below such predetermined level.

It is presently preferred that such dehumidifier 2 is disposed on a top of a toilet tank. Such second means 20 includes a flexible member 14 connected to a connecting member 13 of the tray member 8 in the dehumidifier for transporting water collected in the tray member 8 to such toilet tank 4 for removal of such water. Such second means 20 further includes a conduit 16 engageable with the toilet tank 4 and connected on a first end thereof to a second end of the flexible member 14 for transporting water from the flexible member 14 to the toilet tank 4.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. In combination with a toilet tank of a toilet in a bathroom an apparatus for removing moisture from such bathroom, the improvement comprising:
(a) a dehumidifier having a predetermined shape and a predetermined size for one of being wall mounted and disposed on a top of said toilet tank;
(b) a first means disposed one of on and in said dehumidifier for collecting water removed from air by said dehumidifier;
(c) a second means engageable with said first means for removing and transporting such water collected by said dehumidifier and disposing said water into said toilet tank;
(d) a power means engageable with said dehumidifier for providing electrical power to said apparatus and
(e) a third means connected to said dehumidifier and said power means for turning said dehumidifier on and off.

2. The combination, according to claim 1, wherein said third means includes a humidity sensor engageable with said power means and disposed one of on and in said dehumidifier for sensing humidity in such bathroom.

3. The combination, according to claim 2, wherein said humidity sensor includes a means for turning on said dehumidifier when such humidity is at a predetermined level and turning off said dehumidifier when such humidity level drops below said predetermined level.

4. The combination, according to claim 1, wherein said first means includes a tray member disposed in said dehumidifier.

5. The combination, according to claim 4, wherein said second means includes a flexible member connected on a first end thereof to a connecting means on said tray member for transporting water collected in said tray member to said toilet tank for removal of such water.

6. The combination, according to claim 5, wherein said second means further includes a conduit engageable with said toilet tank and connected on a first end thereof to a second end of said flexible member for transporting water from said flexible member to said toilet tank.

7. The combination, according to claim 3, wherein said third means further includes a switch means engageable with said dehumidifier for turning on said dehumidifier when said humidity is below said predetermined level.

8. The combination, according to claim 6, wherein said switch means can override said humidity sensor and turn off said dehumidifier when such humidity is above said predetermined level.

9. The combination, according to claim 1, wherein said power means includes one of a standard 110 volt house power and a rechargeable battery.

10. The combination, according to claim 9, wherein said power means is a standard 110 volt house power.

11. The combination, according to claim 1, wherein said dehumidifier includes a desiccant for absorbing moisture and having a means for such moisture to be extracted and removed from said desiccant thereby permitting said desiccant to be reusable.

12. The combination, according to claim 1, wherein said dehumidifier is disposed on a top of said toilet tank.

13. The combination, according to claim 1, wherein said combination further includes a water level indicator disposed on said dehumidifier which will turn off said dehumidifier in case of a plug in said second means.

14. The combination, according to claim 13, wherein said water level indicator further includes a light that turns on indicating that said second means needs to be checked.

15. The combination, according to claim 1, wherein said predetermined shape of said dehumidifier is substantially rectangular.

16. An apparatus for removing moisture from a bathroom, said apparatus comprising:
(a) a dehumidifier having a predetermined shape and a predetermined size for one of being wall mounted and disposed on a top of a toilet tank;
(b) a first means disposed one of on and in said dehumidifier for collecting water removed from air by said dehumidifier;
(c) a second means engageable with said first means for removing and transporting such water collected by said dehumidifier and disposing such water into a toilet tank;
(d) a power means engageable with said dehumidifier for providing electrical power to said dehumidifier; and
(e) a third means connected to said dehumidifier and said power means for turning said dehumidifier on and off.

17. The apparatus, according to claim 16, wherein said third means includes a humidity sensor engageable with said power means and disposed one of on and in said dehumidifier for sensing humidity in such bathroom.

18. The apparatus, according to claim 17, wherein said humidity sensor includes a means for turning on said dehumidifier when such humidity is at a predetermined level and turning off said dehumidifier when such humidity level drops below said predetermined level.

19. The apparatus, according to claim 16, wherein said second means includes a flexible member connected on a first end thereof to a connecting means on a tray member in said dehumidifier for transporting water collected in said tray member to said toilet tank for removal of such water.

20. The apparatus, according to claim 19, wherein said second means further includes a conduit engageable with said toilet tank and connected on a first end thereof to a second end of said flexible member for transporting water from said flexible member to said toilet tank.
